(19) United States
(12) Patent Application Publication
(10) Pub. No.: US 2011/0192009 A1
(43) Pub. Date: Aug. 11, 2011

(54) METHOD FOR ASSEMBLING A DOWN HOLE DRILL

(76) Inventor: Timothy J. Plunkett, Roanoke, VA (US)

(21) Appl. No.: 13/091,790

(22) Filed: Apr. 21, 2011

Related U.S. Application Data
(63) Continuation of application No. 12/366,014, filed on Feb. 5, 2009.

(51) Int. Cl. B23P 11/02

(52) U.S. Cl. 29/447

(57) ABSTRACT

A method for assembling a down hole drill comprises the steps of providing a cylindrical casing and a fluid distributor cylinder. Prior to assembly, the casing inner diameter is smaller than the fluid distributor cylinder outer diameter. A preassembly thermal treatment step is executed, in which the casing is heated to increase the casing inner diameter, or the distributor cylinder is cooled to decrease the distributor outer diameter, or both the casing is heated and the distributor cylinder is cooled. The distributor cylinder is then inserted into the cylindrical casing, and threaded into threads inside the cylindrical casing. Thermal energy is transferred between the cylindrical casing and the distributor cylinder, causing the casing inner diameter and the fluid distributor cylinder outer diameter to return to their preassembly sizes. This results in an interference fit along the outer surface of the distributor cylinder and the inner surface of the cylindrical casing.

This application is a continuation of U.S. patent application Ser. No. 12/366,014 filed Feb. 5, 2009.

The present invention relates to down-hole drills, and more particularly to devices for distributing percussive fluid in down-hole drills.

Down-bole drills typically include a piston that reciprocates within a casing and impacts upon a bit, so as to drive a bit head into cutting engagement with a work surface. The piston is generally operated by means of a percussive fluid (e.g., compressed air) which is appropriately directed onto surfaces of the piston to cause the piston to displace in opposing directions along a casing axis. Specifically, a drive chamber and a return chamber are typically defined within the casing, with fluid in the drive chamber acting to displace the piston toward the bit and fluid in the return chamber acting to displace the piston back to a drive position spaced above the bit.

To facilitate the proper channeling of percussive fluid, down-hole drills are often provided with a distributor cylinder which includes one or more passages and/or ports to direct fluid from a supply chamber into the drive and/or return chambers, and/or to direct or “exhaust” fluid out of the drive and return chambers. Such distributor cylinders may also partially define the drive, return or/and supply chambers and may interact with or provide valve components for regulating flow between two or more chambers.

### SUMMARY OF THE INVENTION

The present invention provides a method for assembling a percussive drill assembly, the method comprising the steps of: providing a cylindrical casing having an upper end, a lower end, a casing bore defining a casing axis and having a casing inner diameter, and internal threads formed in the central bore; providing a distributor cylinder including first and second opposite ends, a distributor bore defining a distributor inner diameter, an outer surface having a distributor outer diameter not less than the casing inner diameter, and exterior threads formed in the outer surface; providing a bit; providing a piston including an upper end having a piston outer diameter smaller than the distributor inner diameter, and a lower end opposite the upper end; executing a preassembly thermal treatment step to temporarily make the distributor outer diameter smaller than the casing inner diameter, the preassembly thermal treatment step comprising at least one of (a) heating the casing to increase the casing inner diameter, and (b) cooling the distributor cylinder to decrease the distributor outer diameter; while the distributor outer diameter is temporarily smaller than the casing inner diameter, inserting the distributor cylinder into the casing bore; while the distributor outer diameter is temporarily smaller than the casing inner diameter and after inserting the distributor cylinder into the casing bore, simultaneously axially displacing the distributor cylinder along the casing axis and angularly displacing the distributor cylinder about the casing axis to interlock the external threads of the distributor cylinder and the internal threads of the casing; after interlocking the external threads of the distributor cylinder and the internal threads of the casing, transferring thermal energy between the casing and the distributor cylinder to reverse the preassembly thermal step and form an interference fit between the distributor cylinder and the casing; inserting the piston into the casing such that at least the upper end of the piston extends into the distributor bore; and inserting a portion of the bit into the cylindrical casing such that reciprocation of the piston will result in impact loading on the bit.

In some embodiments, the step of providing a distributor cylinder includes forming the exterior threads adjacent the first end of the distributor cylinder; wherein the step of inserting the distributor cylinder into the casing bore includes inserting the first end of the distributor cylinder into the casing bore from the upper end of the casing; and wherein the step of providing a casing includes forming the internal threads a distance from the upper end of the casing such that the entire distributor cylinder is within the casing bore upon completion of the step of interlocking the external threads of the distributor cylinder and the internal threads of the casing.

In some embodiments, the step of providing a distributor cylinder includes forming radial ports through the distributor cylinder between the outer surface and the distributor bore and forming spiral-shaped passages in the outer surface of the distributor cylinder, the spiral-shaped passages extending from the second end of the distributor cylinder and communicating with the radial ports.

In some embodiments, the method further comprises the steps of defining a fluid supply chamber between the upper end of the casing and the second end of the distributor cylinder; defining a drive chamber between the second end of the distributor cylinder and the upper end of the piston; defining a return chamber between the upper end of the piston and the first end of the distributor cylinder; and disposing a valve member between the supply chamber and the second end of the distributor cylinder, the valve member being movable between an open position in which the valve member places the supply chamber in fluid communication with the drive chamber and a closed position in which the valve member cuts off communication between the supply chamber and the drive chamber; wherein the spiral-shaped passages communicate along the outer surface of the distributor cylinder between the supply chamber and the radial ports; and wherein reciprocation of the upper end of the piston within the distributor cylinder cyclically opens and covers the radial ports to respectively establish and cut off communication between the supply chamber and the return chamber.

In some embodiments, the step of providing a distributor cylinder includes providing a distributor cylinder having an outer diameter that is constant from the first end to the second end such that the entire distributor outer surface has the distributor outer diameter; wherein the step of forming an interference fit includes placing the entire distributor outer surface in contact with the casing bore.

The invention also provides a method for assembling a down hole drill, comprising the steps of: providing a cylindrical casing having a casing bore defining an inner diameter; providing a cylindrical distributor body having an outer diameter that is greater than the inner diameter of the casing; executing a preassembly thermal treatment step to temporarily make the distributor body outer diameter less than the casing inner diameter; inserting the distributor body into the casing bore to a desired axial position while the distributor body outer diameter is less than the casing inner diameter; exchanging thermal energy between the distributor body and casing to reverse the preassembly thermal treatment; and creating an interference fit between the casing and the distributor body in response to reversing the preassembly thermal treatment.

In some embodiments, the preassembly thermal treatment step includes heating the casing to increase the inner diameter of the casing to facilitate insertion of the distributor body into the casing.

In some embodiments, the preassembly thermal treatment step includes cooling the distributor body to decrease the outer diameter of the distributor body to facilitate insertion of the distributor body into the casing.

In some embodiments, the preassembly thermal treatment step includes: heating the casing to increase the inner diameter of the casing to facilitate insertion of the distributor body into the casing; and cooling the distributor body to decrease the outer diameter of the distributor body to facilitate insertion of the distributor body into the casing.

In some embodiments, the casing has upper and lower ends and a central axis extending between the upper and lower ends; the method further comprising: providing internal threads in the casing bore; and providing external threads on the distributor body; wherein the step of inserting the distributor body into the casing bore includes axial movement of the distributor body followed by rotational and axial movement of the distributor body to engage the external threads of the distributor body into the internal threads of the casing.

In some embodiments, the step of inserting the distributor body into the casing includes inserting the distributor body into the upper end of the casing; and wherein the step of forming the internal threads in the casing bore includes forming the internal threads a distance from the upper end such that the entire distributor cylinder is within the casing bore upon completion of the step of engaging the external threads of the distributor body into the internal threads of the casing.

In some embodiments, the step of providing a distributor body includes providing a distributor body having first and second opposite ends, an outer surface defining the outer diameter, and a distributor bore, the method further comprising the steps of: providing a piston having an upper end; inserting the upper end of the piston into the distributor bore; defining a fluid supply chamber within the cylindrical casing above second end of the distributor body; defining a drive chamber within the distributor bore between the second end of the distributor body and the upper end of the piston; defining a return chamber within the distributor bore between the upper end of the piston and the first end of the distributor body; providing a radial port in the distributor body, the radial port communicating between the distributor bore and the outer surface; providing a fluid passage in the outer surface, the fluid passage extending from the second end of the distributor body and communicating with the radial port; and fluidly coupling the return chamber with the fluid supply chamber by way of the fluid passage and radial port.

In some embodiments, the method further comprises: providing a valve between the fluid supply chamber and the drive chamber; moving the valve to an open position to establish communication between the fluid supply chamber and the drive chamber; and moving the valve to a closed position to cut off communication between the fluid supply chamber and the drive chamber.

In some embodiments, the method further comprises: reciprocating the piston within the cylindrical casing; opening the radial port with the upper end of the piston in response to reciprocation of the piston to establish communication between the fluid supply chamber and the return chamber through the fluid passage and radial port; and closing the radial port with the upper end of the piston in response to reciprocation of the piston to cut off communication between the fluid supply chamber and the return chamber through the fluid passage and radial port.

In some embodiments, providing a fluid passage includes defining a plurality of spiral shaped fluid passages in the outer surface of the distributor body; and wherein providing a radial port includes providing a plurality of radial ports, each radial port communicating between one of the plurality of spiral shaped fluid passages and the bore within the distributor body.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIGS. 1A and 1B, collectively FIG. 1, are each an axial cross-section view of a drill assembly including a distributor cylinder in accordance with the present invention, FIG. 1A showing a piston in an impact position and FIG. 1B showing the piston in a drive position;

FIG. 2 is an enlarged, partly broken away axial cross-sectional view of the drill assembly, shown with all components removed from the casing except the distributor cylinder;

FIG. 3 is a more enlarged, side perspective view of the distributor cylinder;

FIG. 4 is a side view of the distributor cylinder and an axial cross-sectional view of the casing;

FIG. 5 is another view of the components of FIG. 4, shown with the cylinder inserted into the casing;

FIG. 6 is another view of the components of FIG. 4, showing the cylinder threads beginning to engage with casing threads;

FIG. 7 is another view of the components of FIG. 4, showing the threads fully engaged such that the distributor cylinder is located at a desired axial position within the casing;

FIG. 8 is broken-away, greatly enlarged view of a section of FIG. 7;

FIG. 9 is an enlarged, broken-away cross-sectional view of the drill assembly, showing the piston at the drive position;

FIG. 10 is another enlarged, broken-away cross-sectional view of the drill assembly, showing the piston at the impact position; and

FIG. 11 is a greatly enlarged, broken-away axial cross-sectional view of an alternative distributor cylinder having a shoulder, shown assembled in the casing.

### DETAILED DESCRIPTION OF THE INVENTION

Certain terminology is used in the following description for convenience only and is not limiting. The words “right”, left”, “lower”, “upper”, “upward”, “down” and “downward” designate directions in the drawings to which reference is made. The words “inner”, “inwardly” and “outer”, “outwardly” refer to directions toward and away from, respectively, a designated centerline or a geometric center of an element being described, the particular meaning being readily apparent from the context of the description. Further, as used herein, the word “connected” is intended to include direct connections between two members without any other members interposed therebetween and indirect connections between members in which one or more other members are interposed therebetween. The terminology includes the words specifically mentioned above, derivatives thereof, and words of similar import.

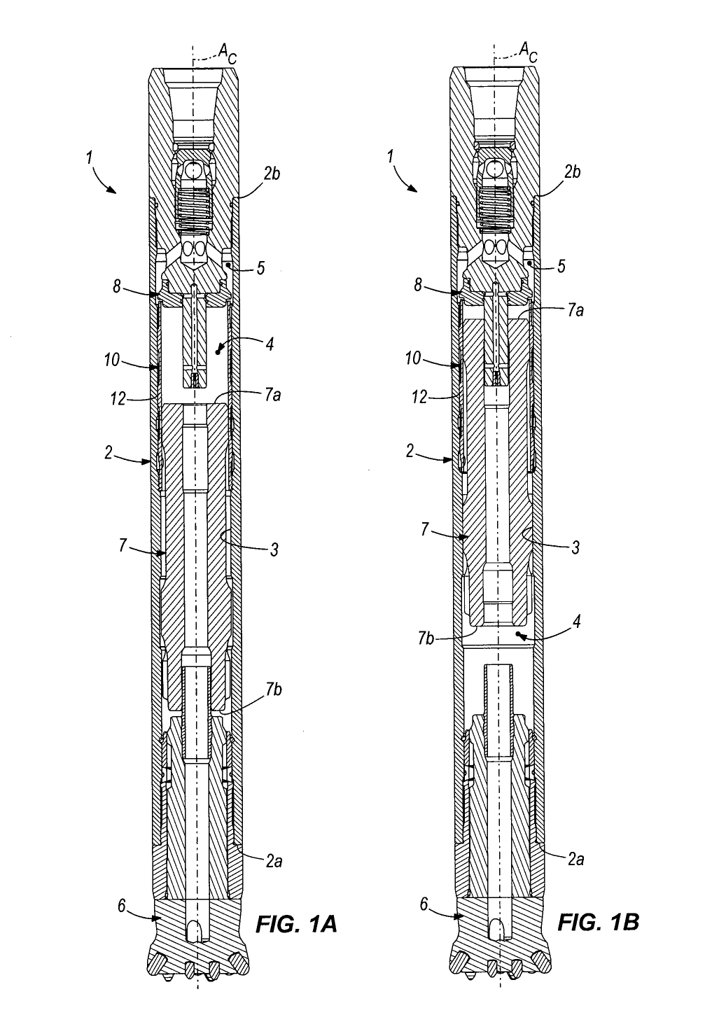

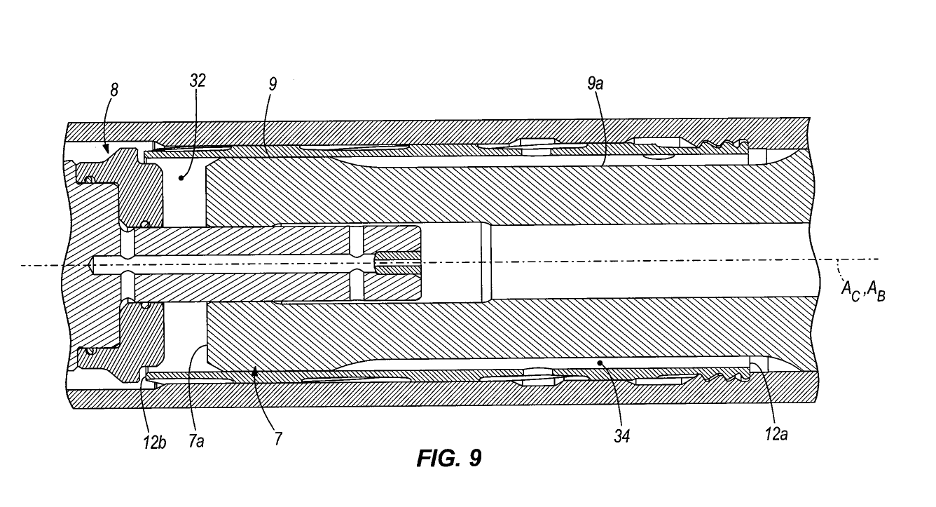

Referring now to the drawings in detail, wherein like numbers are used to indicate like elements throughout, there is shown in FIGS. 1-11 a fluid distributor cylinder 10 for a percussive drill assembly 1. Preferably, the drill assembly 1 includes a casing 2 with lower and upper ends 2a, 2b and having an inner circumferential surface 3 defining a central bore 4, a central axis Ac extending through the bore 4 between the two ends 2a, 2b, and a fluid supply chamber 5 defined within the bore 4. A bit 6 is movably coupled with the casing 2 so as to extend outwardly from the lower end 2a, a piston 7 is movably disposed within the casing bore 4, and a valve member 8 is movably disposed within the casing bore 4 generally between the piston 7 and the casing upper end 2b, the valve 8 regulating flow from the supply chamber 5. Basically, the distributor cylinder 10 comprises a generally tubular body 12 disposeable within the casing bore 4 and configured to receive an upper portion 7a of the piston 7. The body 12 has first and second ends 12a, 12b, a central axis Ac extending generally between the two ends 12a, 12b, and inner and outer circumferential surfaces 13, 14, respectively. The distributor bore 4 is sized to receive the piston 7 such that the piston 7 extends through the body first end 12a, and the body second end 12b is configured to receive the valve member 8, as described in greater detail below. Further, at least a portion 15 of the outer surface 14, preferably a substantial portion of and most preferably generally the entire outer surface 14, is configured to engage with the inner surface 3 of the casing 2 so to form an interference or friction fit between the body 12 and the casing 2. Furthermore, the distributor body 12 also has either an exterior thread 16 or a radially-extending shoulder 18 (see FIG. 11) configured to releasably engage with the casing inner surface 3 so as to substantially prevent axial displacement of the distributor body 12 with respect to the casing 2.

More specifically, the exterior thread 16 or the radial shoulder 18 is configured to prevent displacement of the distributor body 12 relative to the casing 2 when an impact force F₁ is applied to the body 12 and/or the casing 2 that has a magnitude greater than a friction force F_{f} between the body outer surface section 14 and the casing inner surface 3. In other words, the thread 16 or the shoulder 18 functions to retain the distributor 10 at a substantially fixed position P_{D} on the casing axis A_{C} even when an axial force F_{A} is applied to the drill assembly 1 that would otherwise tend to separate the frictionally engaged surfaces 3, 15. Such a force F_{A} may be generated in reaction to the impact force F₁ exerted by the bit 6 on a working surface (e.g., bottom of hole being drilled, not depicted) and the impact force of the piston 7 on the bit 6, and could potentially dislodge the cylinder 10 from the desired axial position P_{D}, and thereby cause the drill assembly 1 to malfunction. Thus, the thread 16 or shoulder 18 provides an additional safeguard to ensure proper operation of the drill assembly 1.

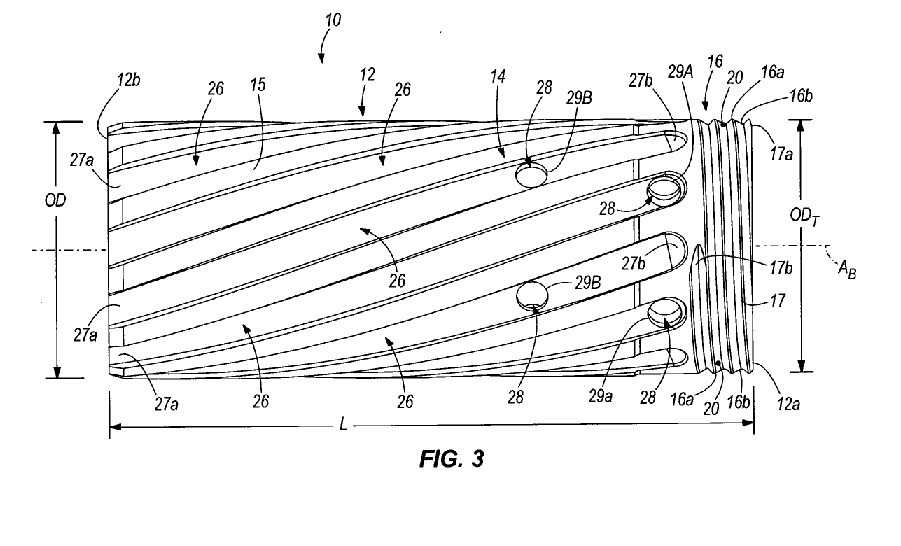

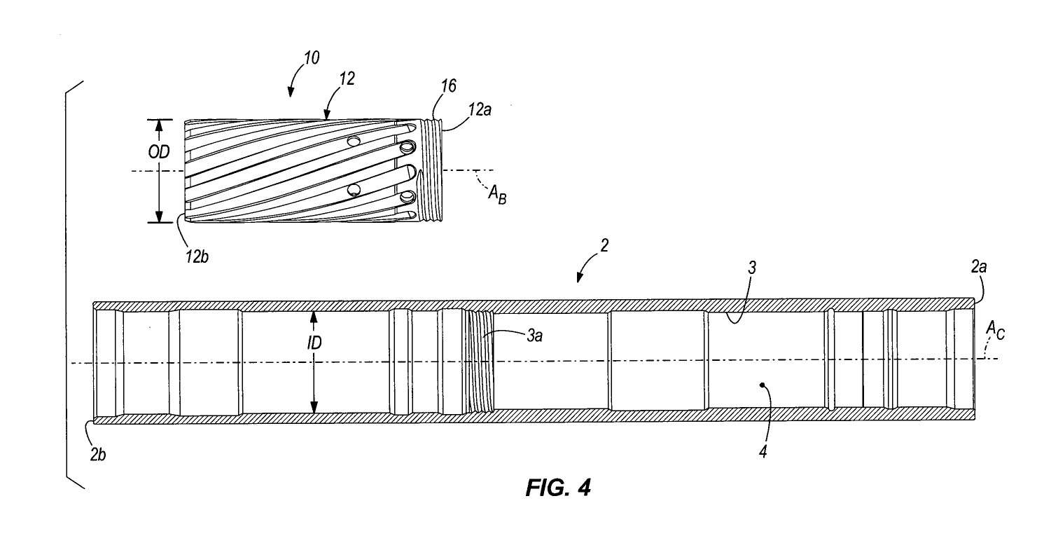

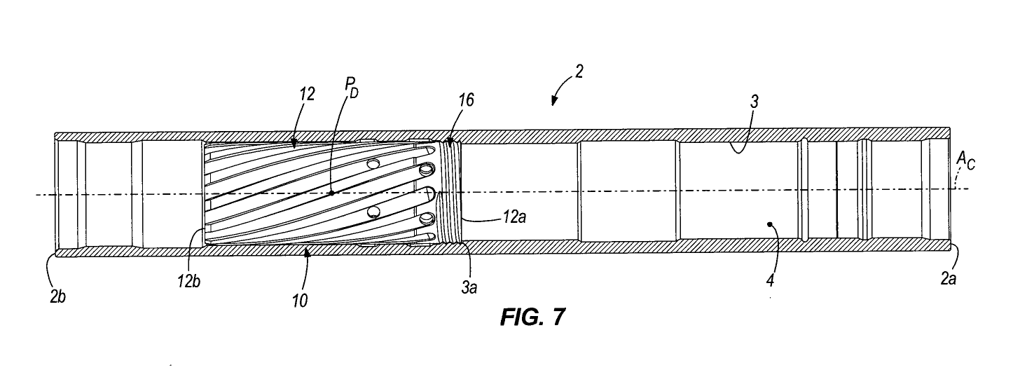

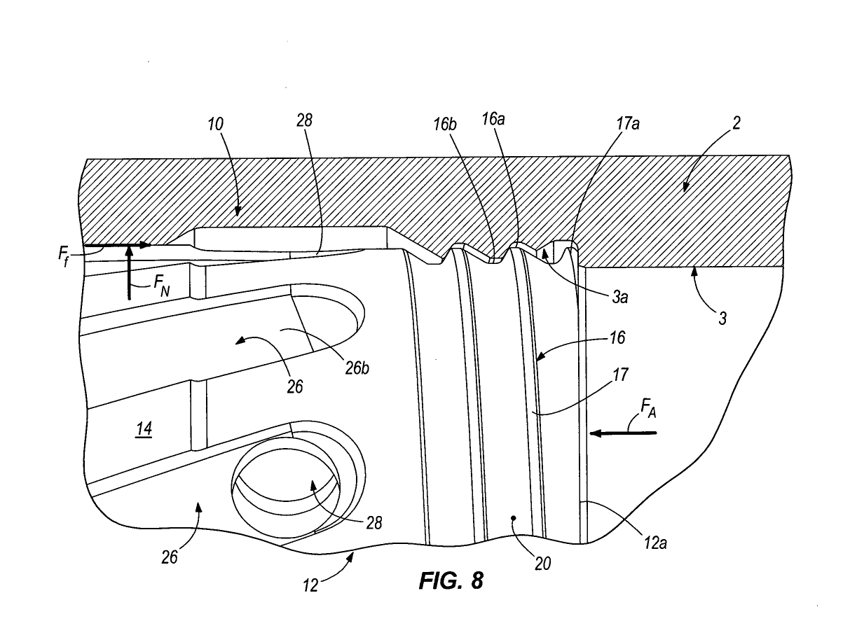

Referring to FIGS. 3-8, the distributor body 12 is formed with an outside diameter OD that is greater than a casing inside diameter ID, such that the friction fit is formed when the distributor cylinder 10 is installed within the casing 2, as described below. Specifically, the distributor body 12 is sized such that the value of the body outside diameter OD is greater than the value of the casing inside diameter ID when the distributor cylinder 10 is separate from the casing 3, as depicted in FIG. 4. However, when the distributor cylinder 10 is disposed within the casing 2, the outer surface 14 of distributor body 12 must be disposed within the casing inner surface 3, i.e., the casing inner surface 3 extends circumferentially about the distributor outer surface 14 (see, e.g., FIG. 7). Thus, the difference between the diameters OD, ID of the unassembled components 2, 12 cause the distributor outer surface 14 to push outwardly against the casing inner surface 3, and vice-versa, thereby generating a generally radial normal force F_{N} (FIG. 8) and a resulting generally axial frictional force F_{F} whenever a net axial force F_{A} is applied to either the casing 2 or the distributor body 12. Preferably, the value of the body outside diameter OD is about 0.1 percent greater than the value of the casing inside diameter ID, and most preferably the body outside diameter OD is about 0.001 inches greater the casing inside diameter ID.

Still referring to FIGS. 3-8, the fluid distributor 10 preferably includes a thread 16 as opposed to a shoulder, which is thus an exterior thread. The thread 16 extends circumferentially about the body axis A_{B} and has an outer surface 17 with an outside diameter OD_{T}, which is preferably substantially equal to the main body surface section outside diameter OD. In other words, the thread 16 is preferably formed by cutting one or more grooves 20 into the body 12, i.e., radially inwardly from the body outer surface 14. As such, the crest 16a of the thread 16 is substantially located at the body outside diameter OD and the thread root(s) 16b is located at the base of the groove 20, as best shown in FIGS. 3 and 8. However, the thread(s) 16 may be formed (e.g., cast, forged, etc.) on the body 12 such that the thread(s) 16 extend radially outwardly from the outer surface 14 of the remainder of the body 12. In any case, the thread outer surface 17 is configured to engage with the casing inner surface 3, preferably with an interior thread 3a formed into the inner surface 3, so as to form an interference fit between the thread 16 and the casing 2 (i.e., in addition to threadably interlocking) As such, a substantial portion of outer surface 14 of the distributor cylinder 10 contributes to the axially directed friction force F_{F} that counteracts the impact force F_{A}.

Preferably, the one or more threads 16 are formed on the distributor body 12 such that each thread 16 has a first end 17a located at least generally proximal to one of the body first and second ends 12a, 12b and a second end 16b located generally between the first and second ends 12a, 12b. In other words, each thread 16 starts at one end 12a or 12b of the body 12 and extends axially (i.e., and circumferentially) only partway toward the other body end 12b, 12a. Most preferably, the thread first end 17a is located at the body first end 12a and extends toward the body second end 12b for less than about one-tenth of the body overall length L (FIG. 3). With such a thread arrangement, the thread(s) 16 preferably engage with the casing 2 at a location where impact forces F_{A} are likely to be more directly applied to the distributor 10, i.e., the lower, first end 12a, such that the thread 16 prevents any displacement of the body 12 relative to the casing 2. In other words, if the threads 16 were located at the center or second end 12b of the body 12, a force F_{A} applied at the first end 12a could cause displacement of body first end 12a with respect to the central threaded portion (i.e., compression). As such a force F_{A} is applied periodically or cyclically during drill operation as the piston 7 reciprocates, periodic compression of the distributor body 12 may potentially lead to premature fatigue failure. However, as such relative displacement and increased risk of fatigue failure is relatively insubstantial, the threads 16 may alternatively be located centrally or may extend from the second end 12b inwardly toward the first end 12a, which may be desirable for locating other components/portions of the distributor 10 or the casing 2.

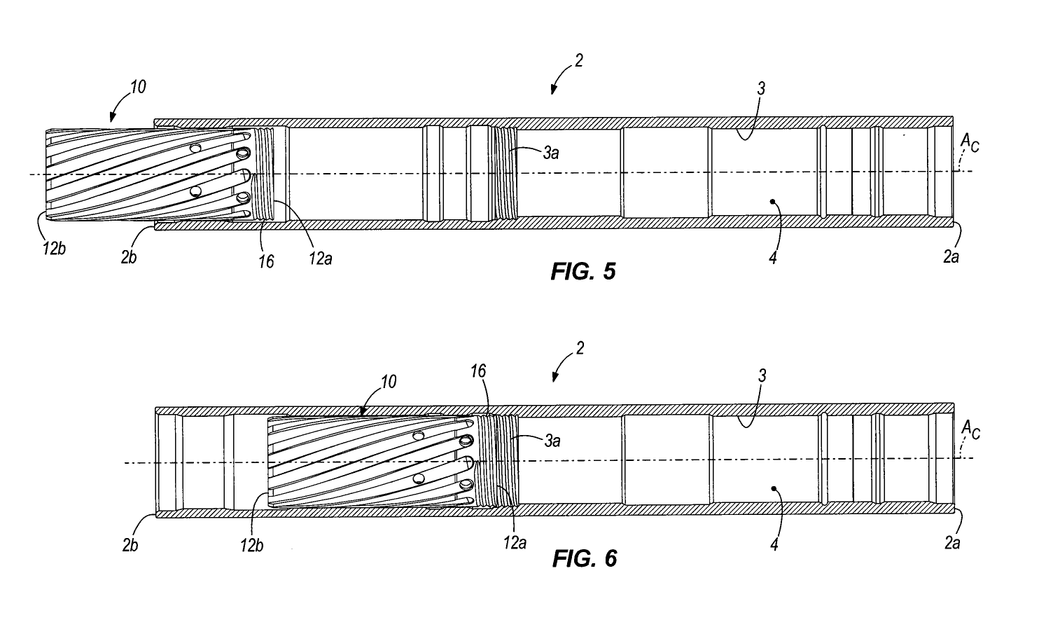

With the above structure, the distributor body 12 is configured for installation within the drill assembly 1 by insertion through the casing upper end 2b, linear displacement along the casing axis A_{C} until the threads 3a, 16 engage, and then simultaneous rotation and displacement about the axis A_{C} until the threads 3a, 16 interlock. More specifically, prior to assembly, the distributor body 12 is either cooled to temporarily reduce the distributor body OD and/or the casing 2 is heated to temporarily increase the casing inner diameter ID, such that the distributor OD is lesser than the casing ID. Once these components 2, 12 are cooled and/or heated, the distributor body first end 12a is first inserted through the upper end 2b of the casing 2, as shown in FIG. 5, and then the body 12 is linearly displaced (e.g., “pushed”) along the axis A_{C} until the first end 17a of the preferred thread 16 engages with the casing interior thread 3a, as depicted in FIG. 6. Thereafter, the distributor body 12 is simultaneously axially displaced along, and angularly displaced about, the casing axis A_{C} until the interior and exterior threads 3a, 16 generally interlock, as shown in FIG. 7. At this point, the distributor body 12 is positioned at the desired location or position P_{D} on the casing axis A_{C}, at which the distributor cylinder 10 is capable of interacting with other components of the drill assembly 1, as discussed below. Eventually, sufficient thermal energy is transferred to the body 12 and/or out of the casing 2 such that the distributor body 12 expands and/or the casing 2 shrinks so as to form the interference fit as described above, thereby securing the body 12 at the desired axial position P_{D}.

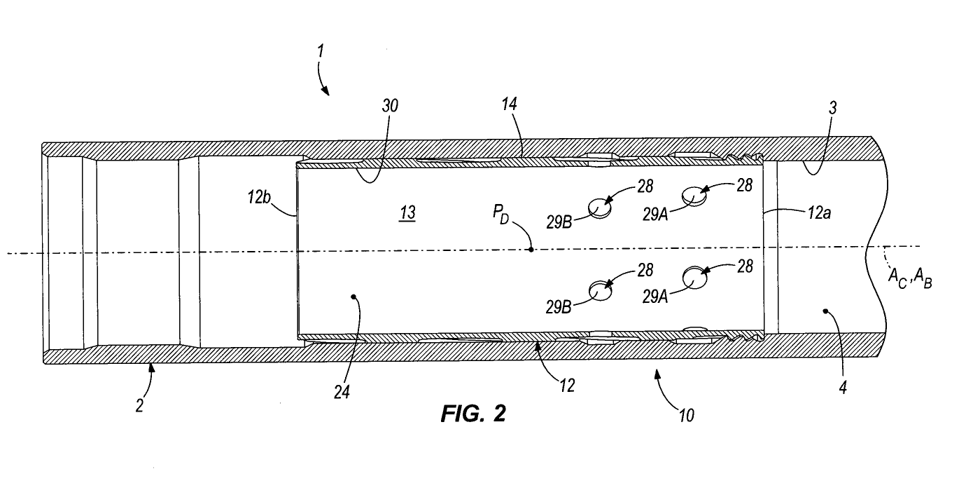

Referring now to FIGS. 2, 3, 9 and 10, the distributor body 12 preferably further has at least one interior chamber 24 (FIG. 2), at least one and preferably a plurality of generally axial fluid passages 26, and at least one and preferably a corresponding number of radial ports 28. More specifically, the body inner circumferential surface 13 defines a central bore 30 extending between the body axial ends 12a, 12b, such that the body 12 is generally tubular. The bore 30 is sized to receive an upper portion 7a of the piston 7 so that a plurality of chambers arc defined or definable in sections of the bore 30 and partly bounded by surfaces of the piston 7. Specifically, a drive chamber 32 is defined in the bore 30 between the upper end 12b of the distributor body 12 and the upper end 7a of the piston 7 and a return chamber 34 is defined between the upper end 7a of the piston 7 and the lower end 12a of the distributor body 12. More specifically, the piston 7 has an outer surface 9 extending between the piston upper and lower ends 7a, 7b, which includes a radially-inwardly stepped portion 9a, and the return chamber 34 is defined between the outer surface stepped portion 9a and a circumferentially overlapping section(s) of the distributor body inner surface 13. Being partly defined by the movable piston 7, the relative sizes of the drive chamber 32 and the return chamber 34 are variable, and specifically are inversely related, i.e., the size/volume of the drive chamber 32 increases as the supply chamber 34 decreases, and vice-versa.

Further, the one or more fluid passages 26 extend generally axially from the second, upper end 12b of the distributor body 12 and toward the body first, lower end 12a. Preferably, each passage 26 extends partially circumferentially, so as to be generally spiral-shaped. More specifically, each passage 26 has a first end 27a at the distributor body second end 12b and a second end 26b spaced from the body first end 12a, and extends radially inwardly from the body outer surface 14. Furthermore, each radial port 28 extends radially between the distributor body inner and outer surfaces 13, 14 and into a separate one of the fluid passages 26. Preferably, the ports 28 are axially “staggered” such that a first, lower set of ports 29A are each located proximal to the second end 26b of the associated passage 26 and a second, upper set of ports 29B are each spaced generally axially from the second end 26b. As such, the rate of fluid flow through the ports 28, and thus between the supply chamber 5 and the return chamber 34, can be varied depending on the location of the piston 7, as discussed in greater detail below.

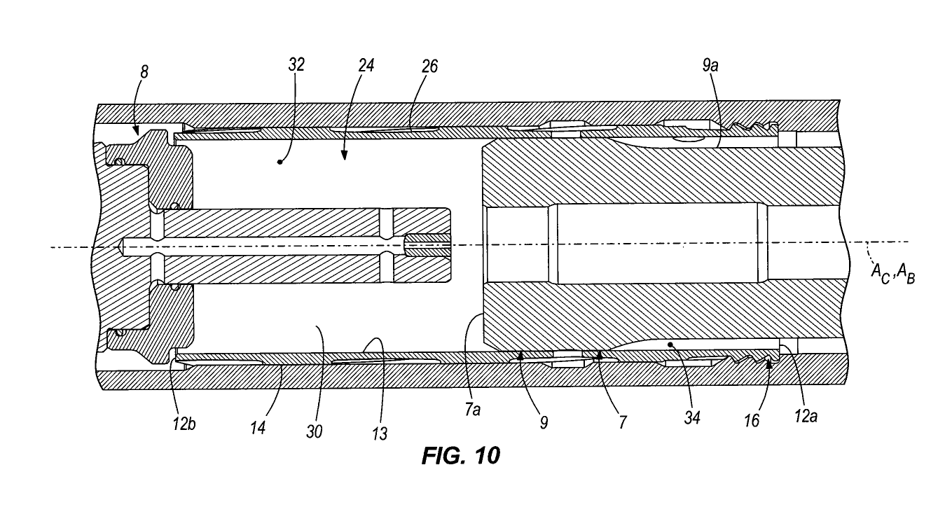

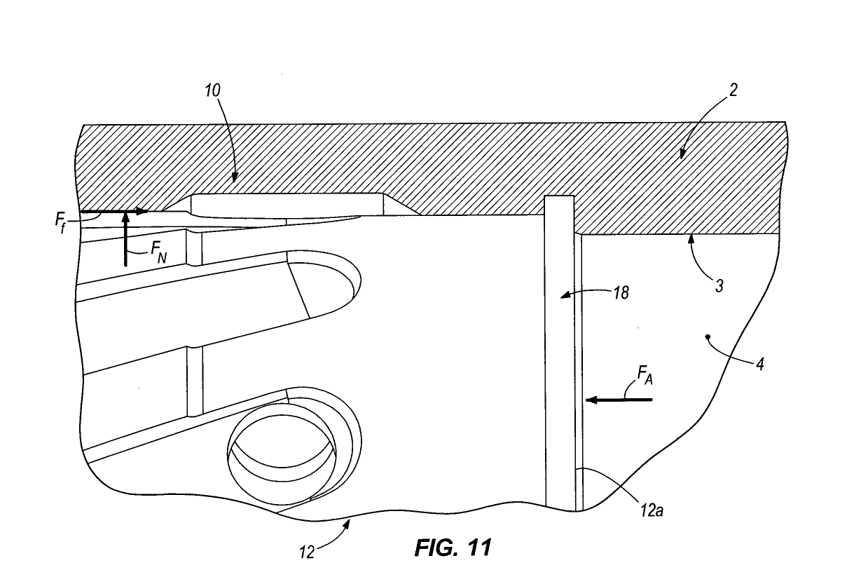

Referring to FIGS. 1, 9 and 10, the distributor body 12 is preferably arranged in the casing 2 such that the body second, upper end 12b is located proximal to the fluid supply chamber 5. The valve member 8 is disposed within the casing 2 generally between the supply chamber 5 and the distributor cylinder 10 and is displaceable between an open position V_{O} (e.g., FIG. 10) and a closed position (not shown). In the open position V_{O}, the valve member 8 is axially spaced from the distributor body second end 12b such that the supply chamber 5 is fluidly coupled with the drive chamber 32. In the closed position, the valve member 8 is engaged with the body second end 12b, such that the valve member 8 is configured to substantially prevent fluid flow between the supply and drive chambers 5, 32 and permit flow between the supply and return chambers 5, 34. Specifically, fluid flows from the supply chamber 5 into the first ends 27a of fluid passages 26, through each passage 26 to the associated port 28, and thereafter into the return chamber 34. In certain positions of the piston 7, both sets of ports 29A, 29B are open, such that the flow into the return chamber 34 is maximized. However, in other positions, the piston 7 is axially located such that a section of the outer surface 9 extends across and seals the second, upper set of ports 29B (see, e.g., FIG. 10), so that the flow into the return chamber 34 is minimized.

Although preferably formed as described above, the distributor cylinder 10 may be constructed in any other appropriate manner. For example, the body 12 may be formed to provide at least a portion of the supply chamber 5, having a valve member disposed inside the bore 30 and engageable with a shoulder providing a valve seat, and including additional radial ports fluidly coupling supply chamber with the fluid passages 26. Further for example, the distributor cylinder 10 may be formed without any fluid passages and only include radial ports 28 fluidly connecting the return chamber 32 with fluid passages formed in the casing inner surface 3. The scope of the present invention includes these and all other distributor cylinder constructions that are configured to engage with a casing inner surface 3 with an interference fit and including one or more exterior threads 16 or/and a radial shoulder 18.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined herein.

1. A method for assembling a percussive drill assembly, the method comprising the steps of:
providing a cylindrical casing having an upper end, a lower end, a casing bore defining a casing axis and having a casing inner diameter, and internal threads formed in the central bore;
providing a distributor cylinder including first and second opposite ends, a distributor bore defining a distributor inner diameter, an outer surface having a distributor outer diameter not less than the casing inner diameter, and exterior threads formed in the outer surface;
providing a bit;
providing a piston including an upper end having a piston outer diameter smaller than the distributor inner diameter, and a lower end opposite the upper end;
executing a preassembly thermal treatment step to temporarily make the distributor outer diameter smaller than the casing inner diameter, the preassembly thermal treatment step comprising at least one of (a) heating the casing to increase the casing inner diameter, and (b) cooling the distributor cylinder to decrease the distributor outer diameter;
while the distributor outer diameter is temporarily smaller than the casing inner diameter, inserting the distributor cylinder into the casing bore;
while the distributor outer diameter is temporarily smaller than the casing inner diameter and after inserting the distributor cylinder into the casing bore, simultaneously axially displacing the distributor cylinder along the casing axis and angularly displacing the distributor cylinder about the casing axis to interlock the external threads of the distributor cylinder and the internal threads of the casing;
after interlocking the external threads of the distributor cylinder and the internal threads of the casing, transferring thermal energy between the casing and the distributor cylinder to reverse the preassembly thermal step and form an interference fit between the distributor cylinder and the casing;
inserting the piston into the casing such that at least the upper end of the piston extends into the distributor bore; and
inserting a portion of the bit into the cylindrical casing such that reciprocation of the piston will result in impact loading on the bit.

2. The method of claim 1, wherein the step of providing a distributor cylinder includes forming the exterior threads adjacent the first end of the distributor cylinder; wherein the step of inserting the distributor cylinder into the casing bore includes inserting the first end of the distributor cylinder into the casing bore from the upper end of the casing; and wherein the step of providing a casing includes forming the internal threads a distance from the upper end of the casing such that the entire distributor cylinder is within the casing bore upon completion of the step of interlocking the external threads of the distributor cylinder and the internal threads of the casing.

3. The method of claim 1, wherein the step of providing a distributor cylinder includes forming radial ports through the distributor cylinder between the outer surface and the distributor bore and forming spiral-shaped passages in the outer surface of the distributor cylinder, the spiral-shaped passages extending from the second end of the distributor cylinder and communicating with the radial ports.

4. The method of claim 3, further comprising the steps of defining a fluid supply chamber between the upper end of the casing and the second end of the distributor cylinder; defining a drive chamber between the second end of the distributor cylinder and the upper end of the piston; defining a return chamber between the upper end of the piston and the first end of the distributor cylinder; and disposing a valve member between the supply chamber and the second end of the distributor cylinder, the valve member being movable between an open position in which the valve member places the supply chamber in fluid communication with the drive chamber and a closed position in which the valve member cuts off communication between the supply chamber and the drive chamber; wherein the spiral-shaped passages communicate along the outer surface of the distributor cylinder between the supply chamber and the radial ports; and wherein reciprocation of the upper end of the piston within the distributor cylinder cyclically opens and covers the radial ports to respectively establish and cut off communication between the supply chamber and the return chamber.

5. The method of claim 1, wherein the step of providing a distributor cylinder includes providing a distributor cylinder having an outer diameter that is constant from the first end to the second end such that the entire distributor outer surface has the distributor outer diameter;
wherein the step of forming an interference fit includes placing the entire distributor outer surface in contact with the casing bore.

6. A method for assembling a down hole drill, comprising the steps of:
providing a cylindrical casing having a casing bore defining an inner diameter;
providing a cylindrical distributor body having an outer diameter that is greater than the inner diameter of the casing;
executing a preassembly thermal treatment step to temporarily make the distributor body outer diameter less than the casing inner diameter;
inserting the distributor body into the casing bore to a desired axial position while the distributor body outer diameter is less than the casing inner diameter;
exchanging thermal energy between the distributor body and casing to reverse the preassembly thermal treatment; and
creating an interference fit between the casing and the distributor body in response to reversing the preassembly thermal treatment.

7. The method of claim 6, wherein the preassembly thermal treatment step includes heating the casing to increase the inner diameter of the casing to facilitate insertion of the distributor body into the casing.

8. The method of claim 6, wherein the preassembly thermal treatment step includes cooling the distributor body to decrease the outer diameter of the distributor body to facilitate insertion of the distributor body into the casing.

9. The method of claim 6, wherein the preassembly thermal treatment step includes: heating the casing to increase the inner diameter of the casing to facilitate insertion of the distributor body into the casing; and cooling the distributor body to decrease the outer diameter of the distributor body to facilitate insertion of the distributor body into the casing.

10. The method of claim 6, wherein the casing has upper and lower ends and a central axis extending between the upper and lower ends; the method further comprising:
providing internal threads in the casing bore; and
providing external threads on the distributor body;
wherein the step of inserting the distributor body into the casing bore includes axial movement of the distributor body followed by rotational and axial movement of the distributor body to engage the external threads of the distributor body into the internal threads of the casing.

11. The method of claim 10, wherein the step of inserting the distributor body into the casing includes inserting the distributor body into the upper end of the casing; and wherein the step of forming the internal threads in the casing bore includes forming the internal threads a distance from the upper end such that the entire distributor cylinder is within the casing bore upon completion of the step of engaging the external threads of the distributor body into the internal threads of the casing.

12. The method of claim 6, wherein the step of providing a distributor body includes providing a distributor body having first and second opposite ends, an outer surface defining the outer diameter, and a distributor bore, the method further comprising the steps of:
providing a piston having an upper end;
inserting the upper end of the piston into the distributor bore;
defining a fluid supply chamber within the cylindrical casing above second end of the distributor body;
defining a drive chamber within the distributor bore between the second end of the distributor body and the upper end of the piston;
defining a return chamber within the distributor bore between the upper end of the piston and the first end of the distributor body;
providing a radial port in the distributor body, the radial port communicating between the distributor bore and the outer surface;
providing a fluid passage in the outer surface, the fluid passage extending from the second end of the distributor body and communicating with the radial port; and
fluidly coupling the return chamber with the fluid supply chamber by way of the fluid passage and radial port.

13. The method of claim 12, further comprising: providing a valve between the fluid supply chamber and the drive chamber; moving the valve to an open position to establish communication between the fluid supply chamber and the drive chamber; and moving the valve to a closed position to cut off communication between the fluid supply chamber and the drive chamber.

14. The method of claim 12, further comprising: reciprocating the piston within the cylindrical casing; opening the radial port with the upper end of the piston in response to reciprocation of the piston to establish communication between the fluid supply chamber and the return chamber through the fluid passage and radial port; and closing the radial port with the upper end of the piston in response to reciprocation of the piston to cut off communication between the fluid supply chamber and the return chamber through the fluid passage and radial port.

15. The method of claim 12, wherein providing a fluid passage includes defining a plurality of spiral shaped fluid passages in the outer surface of the distributor body; and wherein providing a radial port includes providing a plurality of radial ports, each radial port communicating between one of the plurality of spiral shaped fluid passages and the bore within the distributor body.
